(19) United States
(12) Patent Application Publication
(10) Pub. No.: US 2025/0230830 A1
(43) Pub. Date: Jul. 17, 2025

(54) ADJUSTABLE EXPANSION ANCHOR BOLT

(71) Applicant: Guangzhou Issyzone Technology Co., Limited, GUANGZHOU (CN)

(72) Inventors: Taiping Yang, Guangzhou (CN); JUN XIAO, Guangzhou (CN)

(21) Appl. No.: 18/882,755

(22) Filed: Sep. 12, 2024

(30) Foreign Application Priority Data
Jan. 11, 2024 (CN) 2024200700756

(51) Int. Cl. F16B 13/06

(52) U.S. Cl. CPC F16B 13/066

(57) ABSTRACT

The utility model discloses an adjustable expansion anchor bolt, including a main sliding block set to be trapezoid-shaped and side sliding blocks respectively slidably installed on two sides of the main sliding block, c a side surface, farther away from the main sliding block, of the side sliding block is set as a vertical surface, a screw is arranged at a top center of the main sliding block, and a manual nut is installed on the screw. Beneficial effects of the utility model are as follows: The trapezoidal main sliding block and the two side sliding blocks that are slidably connected with the main sliding block are arranged, so that a user can reduce a distance between the manual nut and the main sliding block by tightening the manual nut during use.

### CROSS REFERENCE TO RELATED APPLICATIONS

The present application claims the priority of Chinese patent application No. 2024200700756, filed on Jan. 11, 2024, and contents of which are incorporated herein by reference.

### TECHNICAL FIELD

The utility model relates to the technical field of auto parts, and in particular, to an adjustable expansion anchor bolt.

### TECHNICAL BACKGROUND

A UTV off-road vehicle is a special vehicle applicable to off-road driving on beaches, cargo transportation in mountains, or operations on farms, such model is usually equipped with a rear bucket, and multiple installation holes are arranged at an edge of the rear bucket, to provide an extension basis for users to additionally install other devices later. However, as for the rear bucket positions, for the sake of aesthetics, manufacturers of UTV off-road vehicles mostly use blind holes as the foregoing installation holes, for example, an approximately rhombic blind hole 100 shown in FIG. 1 (some models also use square blind holes), and therefore, it is impossible to use penetrating fasteners such as bolts for fixation. Therefore, the manufacturers generally recommend that the user use a rubber cap to install the device, a size of the rubber cap is slightly greater than that of the blind hole 100, and a head of the rubber cap has a round of brim. During use, an installation hole of the device first needs to be aligned with the blind hole 100 in the rear bucket of the UTV, and then the rubber cap is pressed into the blind hole 100 until the brim abuts against an outer edge of the installation hole of the device, to anchor the device through interference fit of the rubber cap and the blind hole 100 and restriction of the brim.

However, because the foregoing rubber cap implements fixation via only frictional force between the rubber cap and the blind hole 100, the rubber cap has insufficient anchoring strength, is likely to loosen, and cannot completely implement anchoring.

### SUMMARY

In view of the foregoing problems, the utility model provides an adjustable expansion anchor bolt, mainly intended to resolve a problem that a rubber plug has insufficient anchoring strength.

To resolve the foregoing technical problem, a technical solution of the utility model is as follows:

An adjustable expansion anchor bolt includes a main sliding block set to be trapezoid-shaped and side sliding blocks respectively slidably installed on two sides of the main sliding block, where a side surface, farther away from the main sliding block, of the side sliding block is set as a vertical surface, a screw is arranged at a top center of the main sliding block, and a manual nut is installed on the screw.

In some embodiments, a restraint hole is also arranged at a bottom center of the main sliding block, a smooth hole vertically penetrating into a top end of the main sliding block is arranged in a surface of the restraint hole, a bottom of the screw is fixed to a restraint member to be fitted with the restraint hole, and the screw is threadedly connected to the manual nut after passing through the smooth hole.

In some embodiments, the restraint hole is a polygonal step.

In some embodiments, the manual nut is a through-hole manual nut.

In some embodiments, a gasket is installed on the screw, and the gasket is located between the manual nut and the main sliding block.

In some embodiments, a sliding groove is arranged on a side, closer to the main sliding block, of the side sliding block, a convex bar fitted with the sliding groove is arranged on a side surface of the main sliding block, and a restraint portion for blocking the convex bar is arranged at a top end of the sliding groove.

In some embodiments, an arc-shaped groove for avoiding the screw is arranged on a side, closer to the screw, of the restraint portion.

In some embodiments, anti-skid lines are arranged on a side, farther away from the main sliding block, of the side sliding block.

Beneficial effects of the utility model are as follows: The trapezoidal main sliding block and the two side sliding blocks that are slidably connected with the main sliding block are arranged, so that a user can reduce a distance between the manual nut and the main sliding block by tightening the manual nut during use. Because the main sliding block restricted by the side sliding blocks cannot perform rotational movement, the main sliding block can only be driven to move upward. In this process, because the main sliding block is trapezoidal, the two side sliding blocks are pushed outward in opposite directions, so that outer vertical surfaces of the two side sliding blocks are tightly pressed against two inner side walls of the blind hole, to be stably anchored into the blind hole.

### BRIEF DESCRIPTION OF THE DRAWINGS

FIG. 1 is a blind hole arranged at an edge of a rear bucket of a UTV off-road vehicle;

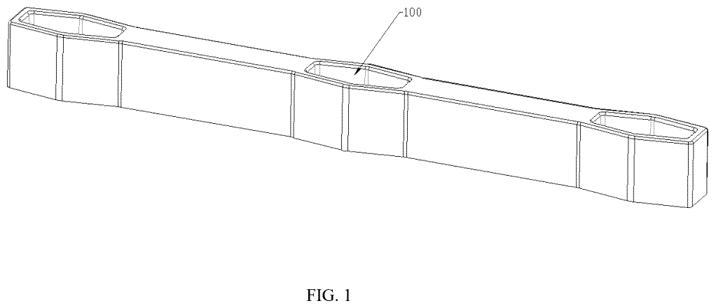

FIG. 2 is a schematic structural diagram of an adjustable expansion anchor bolt disclosed in an embodiment of the utility model;

FIG. 3 is an exploded view of an adjustable expansion anchor bolt disclosed in an embodiment of the utility model; and

FIG. 4 is a schematic diagram of installation of an adjustable expansion anchor bolt disclosed in an embodiment of the utility model.

Reference signs: 100—blind hole; 1—main sliding block; 2—side sliding block; 3—screw; 4—manual nut; 5—restraint hole; 6—smooth hole; 7—restraint member; 8—gasket; 101—convex bar; 201—sliding groove; 202—restraint portion; 203—arc-shaped groove; and 204—anti-skid lines.

### DETAILED DESCRIPTION OF EMBODIMENTS

To make the purpose, the technical solution and the advantage of the utility model clearer and more explicit, content of the utility model is further described in detail below with reference to the accompanying drawings and embodiments. It should be understood that, the embodiments described here are only intended to explain the utility model rather than limit the utility model. In addition, it should also be noted that, for ease of description, only some contents related to the utility model other than all the contents are shown in the drawings.

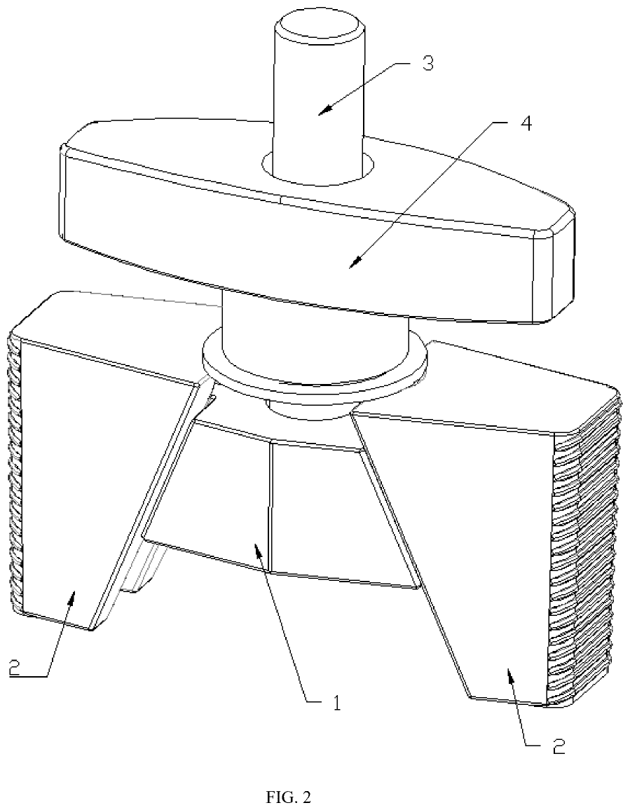

An embodiment provides an adjustable expansion anchor bolt. As shown in FIG. 2, the adjustable expansion anchor bolt includes a main sliding block 1 set to be trapezoid-shaped and side sliding blocks 2 respectively slidably installed on two sides of the main sliding block 1, where a side surface, farther away from the main sliding block 1, of the side sliding block 2 is set as a vertical surface, a screw 3 is arranged at a top center of the main sliding block 1, and a manual nut 4 is installed on the screw 3.

In this embodiment, the trapezoidal main sliding block 1 and the two side sliding blocks 2 that are slidably connected with the main sliding block 1 are arranged, so that a user can reduce a distance between the manual nut 4 and the main sliding block 1 by tightening the manual nut 4 during use. Because the main sliding block 1 restricted by the side sliding blocks 2 cannot perform rotational movement, the main sliding block 1 can only be driven to move upward. In this process, because the main sliding block 1 is trapezoidal, the two side sliding blocks 2 are pushed outward in opposite directions, so that outer vertical surfaces of the two side sliding blocks 2 are tightly pressed against two inner side walls of the blind hole 100, to be stably anchored into the blind hole 100.

In this embodiment, as shown in FIG. 2, it can be seen that the main sliding block 1 is in a shape of a trapezoid (which can be isosceles or non-isosceles) with a narrow top end and a wide bottom end, and therefore, a side, in contact with the main sliding block 1, of the side sliding block 2 needs to be set as sloped outward from top to bottom, so that the two side sliding blocks 2 are pushed outward when the main sliding block 1 is moved upward. However, the foregoing example is only one solution that can achieve an expected function. In another optional solution, the main sliding block 1 can be in a shape of a trapezoid with a wide top end and a narrow bottom end, and therefore, in this solution, a side, in contact with the main sliding block 1, of the side sliding block 2 needs to be sloped inward from top to bottom. On the contrary, the two side sliding blocks 2 are pushed outward when the main sliding block 1 is moved downward.

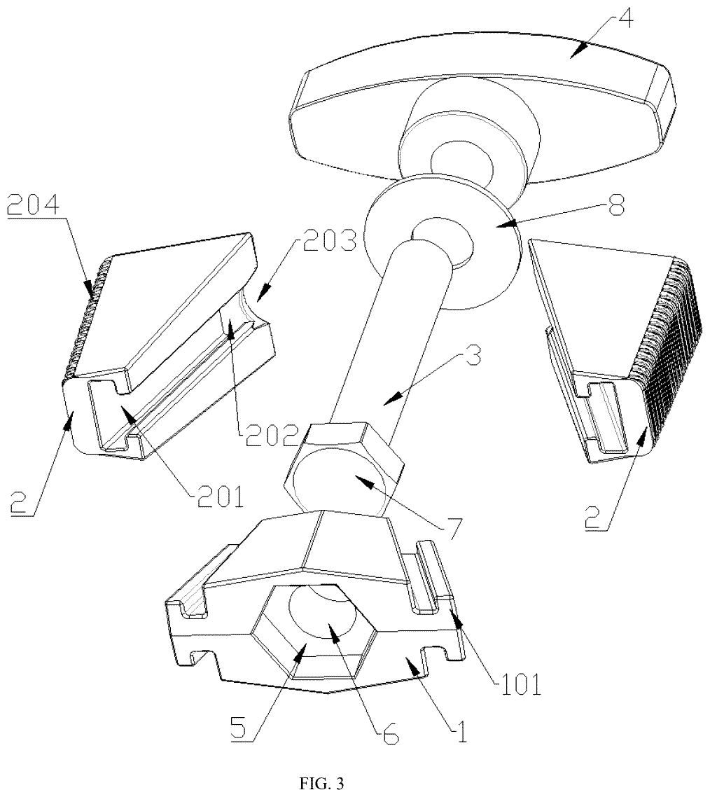

Because the screw 3 needs to be fixed at the top of the main sliding block 1 in the foregoing solution, for manufacturing simplicity of the part, taking the structure shown in FIG. 2 as an example, this embodiment proposes another optimized structure. As shown in FIG. 3, a restraint hole 5 is also arranged at a bottom center of the main sliding block 1, a smooth hole 6 vertically penetrating into a top end of the main sliding block 1 is arranged in a surface of the restraint hole 5, a bottom of the screw 3 is fixed to a restraint member 7 to be fitted with the restraint hole 5, and the screw 3 is threadedly connected to the manual nut 4 after passing through the smooth hole 6. In this solution, a restraint hole is arranged for restricting the restraint member 7 fixedly installed at the bottom of the screw 3, to restrict the rotational movement of the screw 3, and the smooth hole 6 is designed to ensure that the screw 3 can smoothly pass through the bottom of the main sliding block 1 to the top of the main sliding block 1.

Specifically, the restraint hole 5 is a polygonal step. Obviously, the screw 3 and the restraint member 7 can be bolts such as hexagonal bolts. A head of the hexagonal bolt is correspondingly plugged into the restraint hole 5, to restrict rotation of the screw 3.

In this embodiment, in a process of tightening the manual nut 4 on the screw 3, an end cap of the manual nut 4 abuts against the top end of the main sliding block 1 or against the top end of the side sliding block 2, and specific interference depends on a distance by which the two side sliding blocks 2 are pushed apart. Because the manual nut 4 is restricted in a longitudinal direction in the tightening process, actually, the screw 3 drives the main sliding block 1 to jointly move upward, and therefore, the manual nut 4 needs to be set as a through-hole manual nut to provide a passage for the screw 3 to move upward.

Installation holes of some devices are greater than the end cap of the manual nut 4, and the end cap of the manual nut 4 may not tightly press against the installation holes of the devices. To enlarge an application scope of the adjustable expansion anchor bolt, referring to FIG. 2 and FIG. 3, a gasket 8 is installed on the screw 3, the gasket 8 is located between the manual nut 4 and the main sliding block 1, and during use, the gasket 8 needs to abut against a top end surface of the installation hole of the device, to serve as a barrier between the installation hole and the end cap of the manual nut 4.

In this embodiment, the main sliding block 1 is slidably connected, in the examples shown in FIG. 2 and FIG. 3, a sliding groove 201 is arranged on a side, closer to the main sliding block 1, of the side sliding block 2, a convex bar 101 fitted with the sliding groove 201 is arranged on a side surface of the main sliding block 1 to prevent the main sliding block 1 from falling off in a process of sliding upward, and therefore, a restraint portion 202 for blocking the convex bar 101 is arranged at a top end of the sliding groove 201. That is, when the manual nut 4 is tightened, the convex bars 101 on two sides of the main sliding block 1 abut against a bottom end of the restraint portion 202.

On the basis of the foregoing solution, an upper limit position of the main sliding block 1 is controlled to be under the restraint portion 202, and when the main sliding block 1 is at the lowest end, the screw 3 may interfere with the restraint portion 202. Further, an arc-shaped groove 203 for avoiding the screw 3 is arranged on a side, closer to the screw 3, of the restraint portion 202.

As shown in FIG. 3, anti-skid lines 204 are arranged on a side, farther away from the main sliding block 1, of the side sliding block 2, to increase friction force between the side sliding block 2 and an inner wall of the blind hole 100, thereby preventing the installed adjustable expansion anchor bolt from falling off the blind hole 100.

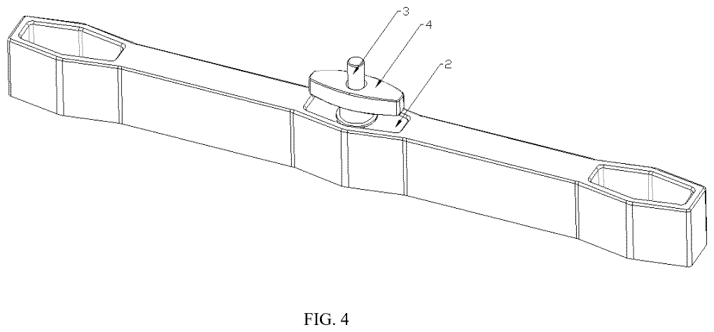

FIG. 4 shows an effect of installing an adjustable expansion anchor bolt onto a blind hole 100 (an installation hole of a device is not shown), and an installation manner of the adjustable expansion anchor bolt is as follows: A screw 3 is firstly inserted through a smooth hole 6 at a bottom of a main sliding block 1 until a restraint member 7 enters a restraint hole 5, and then sliding grooves 201 of two side sliding blocks 2 are partially installed on convex bars 101 of the main sliding block 1 to form sliding connections. After the installed part is put into the blind hole 100, in this case, the screw 3 is exposed outside the blind hole 100, the installation hole of the device requiring installation is aligned with the screw 3 and leveled, and finally, a manual nut 4 is tightened on the screw 3 until the manual nut 4 can no longer be tightened, indicating that the two side sliding blocks 2 have been tightly anchored into the blind hole 100.

The foregoing embodiments are only intended to illustrate a technical idea and characteristics of the utility model, so that persons of ordinary skills in the art can understand content of the utility model and implement it accordingly, and the protection scope of the utility model is not limited thereto. Any equivalent changes or modifications made according to substance of the content of the utility model shall fall within the protection scope of the utility model.

The utility model discloses an adjustable expansion anchor bolt, including a main sliding block set to be trapezoid-shaped and side sliding blocks respectively slidably installed on two sides of the main sliding block, c a side surface, farther away from the main sliding block, of the side sliding block is set as a vertical surface, a screw is arranged at a top center of the main sliding block, and a manual nut is installed on the screw. Beneficial effects of the utility model are as follows: The trapezoidal main sliding block and the two side sliding blocks that are slidably connected with the main sliding block are arranged, so that a user can reduce a distance between the manual nut and the main sliding block by tightening the manual nut during use. Because the main sliding block restricted by the side sliding blocks cannot perform rotational movement, the main sliding block can only be driven to move upward. In this process, because the main sliding block is trapezoidal, the two side sliding blocks are pushed outward in opposite directions, so that outer vertical surfaces of the two side sliding blocks are tightly pressed against two inner side walls of the blind hole, to be stably anchored into the blind hole.

What is claimed is:

1. An adjustable expansion anchor bolt, comprising a main sliding block set to be trapezoid-shaped and side sliding blocks respectively slidably installed on two sides of the main sliding block, wherein a side surface, farther away from the main sliding block, of the side sliding block is set as a vertical surface, a screw is arranged at a top center of the main sliding block, and a manual nut is installed on the screw.

2. The adjustable expansion anchor bolt according to claim 1, wherein a restraint hole is also arranged at a bottom center of the main sliding block, a smooth hole vertically penetrating into a top end of the main sliding block is arranged in a surface of the restraint hole, a bottom of the screw is fixed to a restraint member to be fitted with the restraint hole, and the screw is threadedly connected to the manual nut after passing through the smooth hole.

3. The adjustable expansion anchor bolt according to claim 2, wherein the restraint hole is a polygonal step.

4. The adjustable expansion anchor bolt according to claim 1, wherein the manual nut is a through-hole manual nut.

5. The adjustable expansion anchor bolt according to claim 1, wherein a gasket is installed on the screw, and the gasket is located between the manual nut and the main sliding block.

6. The adjustable expansion anchor bolt according to claim 1, wherein a sliding groove is arranged on a side, closer to the main sliding block, of the side sliding block, a convex bar fitted with the sliding groove is arranged on a side surface of the main sliding block, and a restraint portion for blocking the convex bar is arranged at a top end of the sliding groove.

7. The adjustable expansion anchor bolt according to claim 6, wherein an arc-shaped groove for avoiding the screw is arranged on a side, closer to the screw, of the restraint portion.

8. The adjustable expansion anchor bolt according to claim 1, wherein anti-skid lines are arranged on a side, farther away from the main sliding block, of the side sliding block.
